(19) United States
(12) Patent Application Publication
(10) Pub. No.: US 2026/0093116 A1
(43) Pub. Date: Apr. 2, 2026

(54) OPTICAL COMBINER AND OPTICAL DEVICE USING THE SAME

(71) Applicant: HTC Corporation, Taoyuan City (TW)

(72) Inventor: Qing-Long DENG, Taoyuan City (TW)

(21) Appl. No.: 19/178,895

(22) Filed: Apr. 15, 2025

Related U.S. Application Data
(60) Provisional application No. 63/633,866, filed on Apr. 15, 2024.

(51) Int. Cl. G02B 27/01

(52) U.S. Cl. CPC G02B 27/0172

(57) ABSTRACT

An optical device includes a light-emitting element and an optical combiner. The light-emitting element is configured to emit a type of invisible light. The optical combiner is disposed in an optical path of the type of invisible light. The optical combiner includes a light-transmitting substrate and a series of phosphors. The series of phosphors are disposed on the light-transmitting substrate and are configured to be excited by the type of invisible light to emit a type of visible light.

### CROSS-REFERENCE TO RELATED APPLICATION

This application claims priority to U.S. Provisional Application Ser. No. 63/633,866, filed on Apr. 15, 2024, which is herein incorporated by reference.

### BACKGROUND

### Technical Field

The present disclosure relates to an optical combiner and an optical device using the same.

### Description of Related Art

The current state of augmented reality (AR) devices involves various optical elements such as reflective mirrors and lenses, which are generally colorless and transparent, thus having minimal impact on the color of the original image source, aside from inherent component light loss. However, in AR devices utilizing waveguide elements, the inherent wavelength and angular selectivity of these waveguides introduces challenges in color reproduction. Specifically, when an input image passes through the waveguide, different wavelengths of light are diffracted at varying angles and with different efficiencies due to the diffraction/holographic structures. Theoretically, shorter wavelengths like blue light are diffracted at smaller angles, while longer wavelengths like red light are diffracted at larger angles. This difference in diffraction angles and efficiencies across the color spectrum, even with narrow-bandwidth single-color light sources, results in uneven brightness distribution and color dispersion (color fringing). Consequently, when displaying a white image on a waveguide-based AR device, a gradient rainbow-like color shift with non-uniform brightness is readily observable, typically transitioning from blue to red from one side of the viewing area to the other.

A common conventional approach to mitigate this issue involves adjusting the energy ratios of the red, green, and blue light sources in the image projector to compensate for the different diffraction efficiencies and approximate a mixed white light. For instance, if the initial white light energy ratio of red, green, and blue is 3:6:1, and the peak diffraction efficiencies are 3%, 8%, and 2% respectively, the light source might be adjusted to a ratio of 2:1.5:1 to maintain a white light energy balance after diffraction. However, this approach is fundamentally limited by the least efficient color component (e.g., blue light in the given example), forcing the other colors to be adjusted proportionally, thus leading to a significant reduction in the overall brightness of the final displayed image. Moreover, AR devices commonly employ high-transmittance optical elements, including waveguides, which allow ambient light from the real-world environment to pass through to the user's eyes. This ambient light can be superimposed with the colors of the AR image, causing color distortions. For example, using an AR device in a yellow-lit environment can cause the AR image to appear yellowish. Traditional color correction methods that only focus on adjusting the virtual image light source often neglect or are significantly affected by this ambient light, limiting their effectiveness in achieving accurate and uniform color perception.

Accordingly, it is an important issue for the industry to provide an optical combiner and an optical device using the same that are capable of solving the aforementioned problems.

### SUMMARY

An aspect of the disclosure is to provide an optical combiner and an optical device using the same that can efficiently solve the aforementioned problems.

According to an embodiment of the disclosure, an optical combiner includes a light-transmitting substrate and a series of phosphors. The series of phosphors are disposed on the light-transmitting substrate and are configured to be excited by a type of invisible light to emit a type of visible light.

In an embodiment of the disclosure, the series of phosphors are distributed in the light-transmitting substrate.

In an embodiment of the disclosure, the series of phosphors are disposed on an edge of the light-transmitting substrate.

In an embodiment of the disclosure, the type of invisible light is infrared light.

In an embodiment of the disclosure, the infrared light has a wavelength of about 940 nm.

In an embodiment of the disclosure, the light-transmitting substrate is a diffractive structure or a reflective structure.

In an embodiment of the disclosure, the optical combiner further includes another series of phosphors. The another series of phosphors are disposed on the light-transmitting substrate and are configured to be excited by another type of invisible light to emit another type of visible light.

According to an embodiment of the disclosure, an optical device includes a light-emitting element and an optical combiner. The light-emitting element is configured to emit a type of invisible light. The optical combiner is disposed in an optical path of the type of invisible light. The optical combiner includes a series of phosphors configured to be excited by the type of invisible light to emit a type of visible light.

In an embodiment of the disclosure, the optical combiner further includes a light-transmitting substrate. The series of phosphors are distributed in the light-transmitting substrate.

In an embodiment of the disclosure, the optical combiner further includes a light-transmitting substrate. The series of phosphors are disposed on an edge of the light-transmitting substrate.

In an embodiment of the disclosure, the type of invisible light is infrared light.

In an embodiment of the disclosure, the infrared light has a wavelength of about 940 nm.

In an embodiment of the disclosure, the optical combiner further includes a light-transmitting substrate. The light-transmitting substrate is a diffractive structure or a reflective structure.

In an embodiment of the disclosure, the optical device further includes another light-emitting element. The another light-emitting element is configured to emit another type of invisible light. The optical combiner is disposed in an optical path of the another type of invisible light and further includes another series of phosphors. The another series of phosphors are configured to be excited by the another type of invisible light to emit another type of visible light.

In an embodiment of the disclosure, the optical device further includes a controller. The controller is configured to individually control the light-emitting element and the another light-emitting element.

In an embodiment of the disclosure, the optical device further includes a color light sensor and a controller. The color light sensor is configured to generate a sensing signal in response to sensing ambient light. The controller is configured to control the light-emitting element according to the sensing signal.

Accordingly, in the optical combiner and the optical device of the present disclosure, a series of phosphors configured to be excited by a type of invisible light to emit a type of visible light are provided on or distributed within the light-transmitting substrate of the optical combiner. By emitting visible light upon excitation by invisible light, the color of light perceived by the user can be adjusted and enhanced, thereby achieving color balancing and improved visual quality effects for the augmented reality experience. By employing one or more series of phosphors responsive to different invisible light-emitting elements, various color adjustments and effects can be realized, potentially even allowing for dynamic color control. In other words, the present disclosure employs an optical combiner including phosphors that utilize an additive color mixing approach upon excitation by invisible light, thereby enabling effective color management for the generated virtual image that is superimposed on the real world scene. Consequently, the present disclosure effectively addresses issues such as color distortion and limitations in achieving desired color balance encountered in conventional optical devices that rely solely on adjusting the virtual image light-emitting element or are significantly affected by ambient light, thereby enhancing the color fidelity and overall immersion for users within the augmented reality experience. Furthermore, the use of invisible light to excite the phosphors can minimize the visibility of the light-emitting element itself, preventing unwanted visual artifacts.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a schematic view of an optical device according to an embodiment of the present disclosure;

FIG. 2 is a schematic diagram of an optical combiner in FIG. 1;

FIG. 3 is a schematic diagram of additive color mixing;

FIG. 4 is a schematic view of an optical device according to another embodiment of the present disclosure;

FIG. 5 is a schematic view of an optical device according to another embodiment of the present disclosure;

FIG. 6 is a functional block diagram of the optical device in FIG. 5;

FIG. 7 is a partial schematic view of the optical combiner in FIG. 2;

FIG. 8 is a partial schematic view of an optical combiner according to another embodiment of the present disclosure; and

FIG. 9 is a partial schematic view of an optical combiner according to another embodiment of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts. However, specific structural and functional details disclosed herein are merely representative for purposes of describing example embodiments, and thus may be embodied in many alternate forms and should not be construed as limited to only example embodiments set forth herein. Therefore, it should be understood that there is no intent to limit example embodiments to the particular forms disclosed, but on the contrary, example embodiments are to cover all modifications, equivalents, and alternatives falling within the scope of the disclosure.

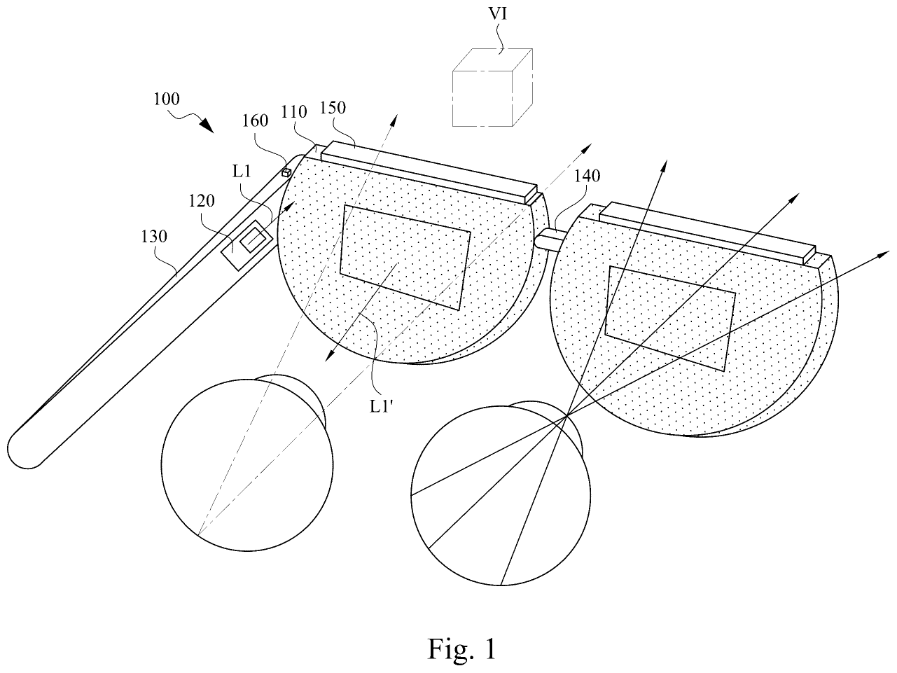

Reference is made to FIG. 1. FIG. 1 is a schematic view of an optical device 100 according to an embodiment of the present disclosure. As shown in FIG. 1, in the present embodiment, the optical device 100 may be used in an augmented reality device which can be implemented as, but is not limited thereto, a pair of glasses or other wearable display devices. Specifically, the optical device 100 includes two optical combiners 110, an image projector 120, a temple 130, and a connecting member 140. The connecting member 140 is connected between the optical combiners 110. The temple 130 is connected to an edge of one of the optical combiners 110. The image projector 120 is disposed on a side of the temple 130 adjacent to the one of optical combiners 110. The optical device 100 may include another temple 130 (not shown) connected to an edge of another of the optical combiners 110. The primary function of each of the optical combiners 110 is to superimpose a virtual image VI generated by the image projector 120 onto the real world scene viewed through the optical combiner 110 by the user.

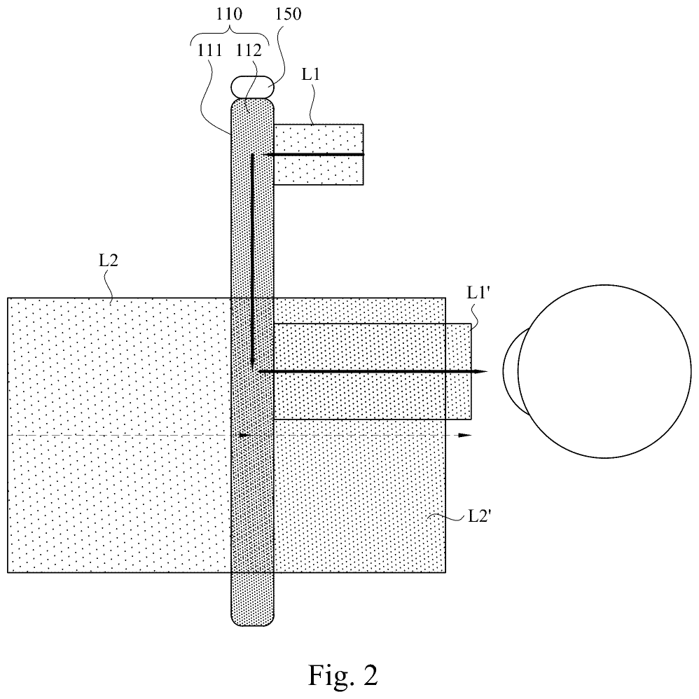

Reference is made to FIG. 2. FIG. 2 is a schematic diagram of the optical combiner 110 in FIG. 1. As shown in FIG. 2 with reference to FIG. 1, in the present embodiment, the image projector 120 is configured to emit image light L1 toward the optical combiner 110. The optical combiner 110 is disposed in an optical path of the image light L1. The optical combiner 110 includes a light-transmitting substrate 111 and a series of phosphors 112. The series of phosphors 112 are disposed on the light-transmitting substrate 111. The optical device 100 further includes a light-emitting element 150. The light-emitting element 150 is configured to emit a type of invisible light. The series of phosphors 112 are configured to be excited by the type of invisible light to emit a type of visible light. Specifically, in the present embodiment, the series of phosphors 112 are distributed in the light-transmitting substrate 111. In this way, the image light L1 entering and propagating in the optical combiner 110 will combine the visible light generated by the series of phosphors 112 to be output as image light L1′, and ambient light L2 will also combine the visible light generated by the series of phosphors 112 to be output as ambient light L2′ after propagating through the optical combiner 110.

In some embodiments, the type of invisible light emitted by the light-emitting element 150 is infrared light. For example, the infrared light has a wavelength of about 940 nm, but the disclosure is not limited thereto. This specific technical choice yields notable benefits from both a functional and a practical standpoint, as detailed below.

Firstly, the utilization of infrared light at about 940 nm provides invisibility to the human eye. This characteristic is paramount in applications where the user's visual experience must remain unimpaired by the operational mechanisms of the device, such as in AR glasses. The rationale behind using invisible light (infrared) at a 940 nm level is to avoid seeing visible bright spots on the optical combiner 110. Directly integrating LED light-emitting chips onto an AR lens as active light sources would obstruct the view of the external world. By employing 940 nm infrared light to excite the series of phosphors 112 embedded within or applied to the optical combiner 110, the excitation source itself remains imperceptible under normal operating conditions. This ensures a seamless and immersive augmented reality experience where the virtual image VI is overlaid on the real world scene without the distraction of a visible light source.

Secondly, the choice of a specific infrared wavelength, about 940 nm, allows for precise and efficient excitation of the series of phosphors 112. Phosphorescent materials are designed to absorb light within a defined spectral range to then emit light at different, usually visible, wavelengths. Selecting an excitation source with a wavelength that closely matches the absorption spectrum of the chosen phosphor ensures optimal energy transfer and, consequently, brighter and more efficient visible light emission. This precision contributes to the fidelity and clarity of the virtual image VI projected to the user.

Thirdly, using an invisible light source about 940 nm infrared mitigates interference from ambient visible light. If a visible light source were used to excite the series of phosphors 112, natural or artificial light in the environment could inadvertently trigger the series of phosphors 112, leading to unwanted light emission or color shifts in the virtual image VI. Using invisible light for excitation prevents the real world's light from exciting the series of phosphors 112, or the image light L1 used to display the virtual image VI from exciting the series of phosphors 112. This is crucial for maintaining the integrity and stability of the augmented reality display across diverse lighting conditions, ensuring that the virtual elements are consistently presented as intended, irrespective of the surrounding environment.

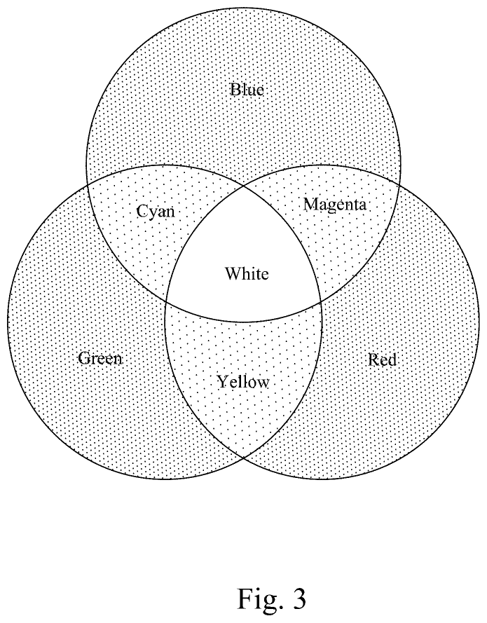

Reference is made to FIG. 3. FIG. 3 is a schematic diagram of additive color mixing. As shown in FIG. 3, additive color mixing, also known as RGB mixing, is based on the principle of combining different wavelengths of light. The primary colors in additive mixing are Red, Green, and Blue. When red and green light are mixed, they produce yellow light; when green and blue light are mixed, they produce cyan light; and when blue and red light are mixed, they produce magenta light. When these three primary colors of light are additively mixed in appropriate proportions, they combine to produce white light.

In typical augmented reality devices, regardless of whether the color light source of the image unit is from LED, Laser, LEDOS, or OLEDOS, the color mixing theory is additive color mixing, for example, [λ_{R}⁽²⁵⁵⁾+λ_{G}⁽²⁵⁵⁾+λ_{B}⁽²⁵⁵⁾] enables the image to ultimately display a white screen. Similarly, because augmented reality devices can directly see through the environmental scenes of the real world, natural light or artificial ambient light is also transmitted to the human eye through additive color mixing methodology. From this discussion, it can be found that the augmented reality devices must simultaneously satisfy the transmission of virtual images and real-world environmental scenes, so they are often described by a light intensity formula and an image intensity contrast formulas respectively:

$${I}_{vision} = {I}_{virtual image} + {I}_{real world scene} \qquad ( 1 )$$

$$Contrast ratio = {I}_{vinual image} / ( {I}_{vinual image} + {I}_{real world scene} ) \qquad ( 2 )$$

where Iᵥᵢₛᵢₒₙ is the total light intensity, I_{virtual image} is the light intensity of the virtual image, and I_{real world scene} is the light intensity of the real world scene.

In this disclosure, the light intensity is further subdivided into visible color light intensities I_{λ}, such as I_{red}, I_{green}, and I_{blue}, where red is the wavelength of about 620 nm to about 750 nm, green is the wavelength of about 495 nm to about 570 nm, and blue is the wavelength of about 450 nm to about 475 nm. Since the visible light wavelength is about 380 nm to about 750 nm, this disclosure is not limited to three segments of color light intensity. After applying the above visible color light intensities to the virtual image and the real world scene, the intensity distribution of each color light can be analyzed separately.

Next, the additive color mixing method is introduced into the optical device 100. For example, when the series of phosphors 112 exhibiting yellow luminescence upon excitation are uniformly doped within the light-transmitting substrate 111 of the optical combiner 110 and are stimulated by the light-emitting element 150 configured to provide invisible light of about 940 nm, the optical combiner 110 functions as a light source emitting in the yellow spectral band. Consequently, the colors of the virtual image VI projected through the optical combiner 110 will undergo additive mixing with the yellow light generated by the series of phosphors 112; likewise, the real world scene viewed through the optical combiner 110 will have a yellow hue superimposed onto it. The overall methodological characteristics can be explained as follows:

$${I}_{λ * ( virtual image )} = {I}_{λ ( virtual image )} + {I}_{λ ( combiner )} \qquad ( 3 )$$

$${I}_{λ * ( real world scene )} = {I}_{λ ( real world scene )} + {I}_{λ ( combiner )} \qquad ( 4 )$$

$${I}_{vision} = {I}_{virtual image} + {I}_{real world scene} \qquad ( 5 )$$

In some other embodiments, when the series of phosphors 112 exhibiting magenta luminescence upon excitation are uniformly doped within the light-transmitting substrate 111 of the optical combiner 110 and are stimulated by the light-emitting element 150 configured to provide invisible light of or other than about 940 nm, the optical combiner 110 functions as a light source emitting in the magenta spectral band. Magenta is a mixture of red light and blue light. When the white image light L1 emitted by the image projector 120 is transmitted to the human eye through the optical combiner 110, the color of the virtual image VI is enhanced in the red light band and the blue light band by additive color mixing. At the same time, the red light band and the blue light band of the ambient light L2′ of the real world scene are also enhanced. Therefore, when the user watches the virtual image VI, he can see the white light image content after the red and blue layers are enhanced. If the virtual image VI is a picture with magenta (such as Peony), the picture will be more vivid.

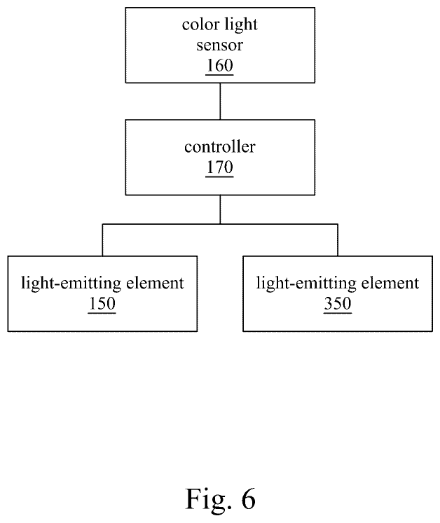

In the embodiment illustrated in FIG. 1, when the virtual image VI is not being projected, the optical device 100 can function solely for enhancing the color wavelengths of the ambient environmental view, much like a pair of color-changing glasses. In the present embodiment, the optical device 100 further includes a color light sensor 160. The color light sensor 160 is configured to detect and read the color levels or color temperature of the ambient light L2 of the real world, and subsequently provide a signal to the system (for example, the controller 170 depicted in FIG. 6, which can be included in the optical device 100 in FIG. 1) to determine whether or not to automatically trigger the light-emitting element 150. In some other embodiments, the light-emitting element 150 may be manually triggered to excite the series of phosphors 112.

As shown in FIG. 1 and FIG. 2, in the present embodiment, the light-transmitting substrate 111 of the optical combiner 110 is a diffractive structure, but the disclosure is not limited thereto.

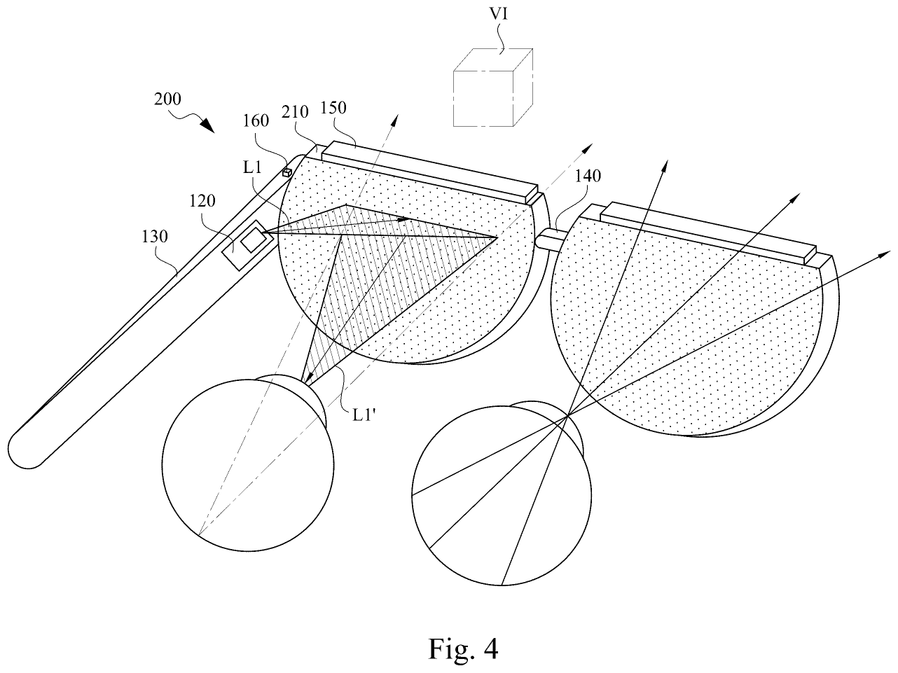

Reference is made to FIG. 4. FIG. 4 is a schematic view of an optical device 200 according to another embodiment of the present disclosure. As shown in FIG. 4, in the present embodiment, the optical device 200 includes two optical combiners 210, an image projector 120, a temple 130, a connecting member 140, two light-emitting elements 150, and a color light sensor 160, in which the image projector 120, the temple 130, the connecting member 140, the light-emitting elements 150, and the color light sensor 160 are identical to those of the embodiment shown in FIG. 1. Therefore, the relevant descriptions of these components can be found in the previous paragraphs and will not be repeated here for simplicity.

It should be pointed out that the light-transmitting substrate 211 of the optical combiner 210 is a reflective structure with the series of phosphors 112 distributed therein. Different from the embodiment shown in FIG. 1, in this embodiment, the virtual image VI is reflected by the optical combiner 210 towards the human eye. Furthermore, because the optical combiner 210 still retains the mechanism where the series of phosphors 112 are excited by invisible light to generate color gradations, the intensity and energy of the visible light color gradations from the series of phosphors 112 can still be superimposed onto the colors of the virtual image VI as well as the colors of the real world scene, ultimately resulting in displayed image content with the enhanced color layer.

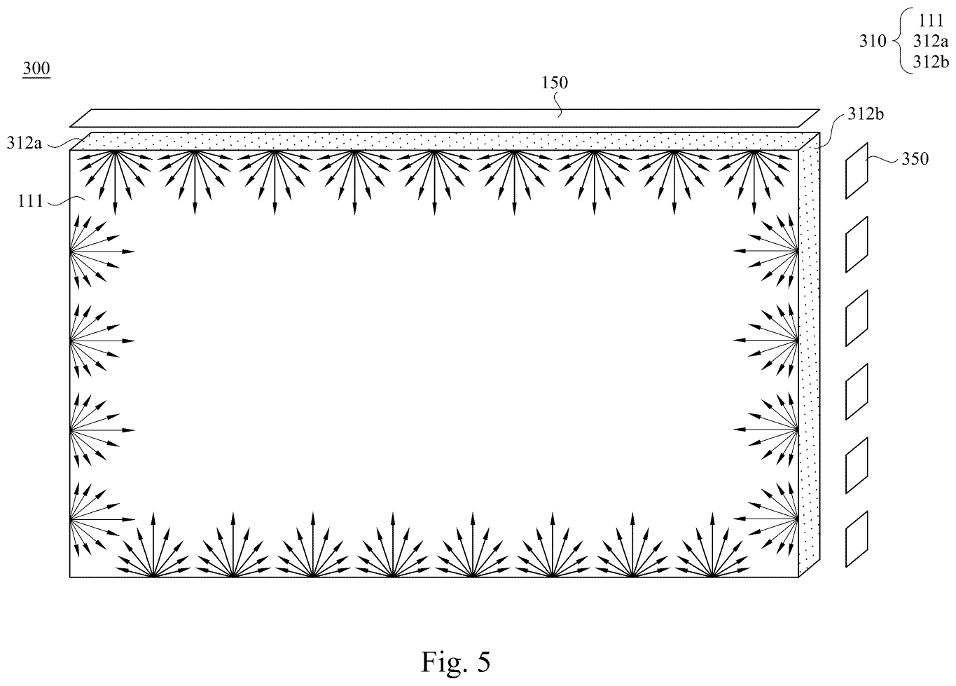

Reference is made to FIG. 5. FIG. 5 is a schematic view of an optical device 300 according to another embodiment of the present disclosure. As shown in FIG. 5, in the present embodiment, the optical device 300 includes an optical combiner 310 and a light-emitting element 150. The optical combiner 310 includes a light-transmitting substrate 111 and a series of phosphors 312a. The series of phosphors 312a are disposed on an edge of the light-transmitting substrate 111 (i.e., the upper edge of the light-transmitting substrate 111 in FIG. 5). The series of phosphors 312a may be identical to the series of phosphors 112 in the embodiment of FIGS. 1 and 2. Therefore, the series of phosphors 312a is configured to be excited by the type of invisible light emitted by the light-emitting element 150 to emit the foregoing type of visible light.

As shown in FIG. 5, in the present embodiment, the optical device 300 further includes a plurality of light-emitting elements 350. The light-emitting elements 350 are configured to emit another type of invisible light. The optical combiner 310 is disposed in an optical path of the another type of invisible light and further includes another series of phosphors 312b. The series of phosphors 312b are disposed on another edge of the light-transmitting substrate 111 (i.e., the right edge of the light-transmitting substrate 111 in FIG. 5). The series of phosphors 312b are configured to be excited by the another type of invisible light to emit another type of visible light. Through the additional light-emitting elements 350 and the corresponding series of phosphors 312b, the present disclosure can achieve a broader color rendering capability or specific color correction functions. For instance, the light-emitting element 150 may emit infrared light with a first wavelength (e.g., about 940 nm) to excite the series of phosphors 312a to generate yellow light, while the light-emitting elements 350 may emit infrared light with a second different wavelength (e.g., about 850 nm) to excite the series of phosphors 312b to generate blue light. In addition, it can be seen that the present disclosure is not limited to using a continuous light-emitting structure (i.e., the light-emitting element 150), but may also use discontinuous light-emitting structures (i.e., the light-emitting elements 350).

By independently or simultaneously controlling the light-emitting element 150 and the light-emitting elements 350, a richer variety of colors can be mixed or presented in the virtual image VI, or precise color adjustments can be performed for specific application scenarios. This design also allows for more flexible adjustment of color performance of the virtual image VI in response to changes in the ambient light L2 by controlling the excitation intensity of different invisible lights, further enhancing the visual quality for the user in the augmented reality experience.

Reference is made to FIG. 6. FIG. 6 is a functional block diagram of the optical device 300 in FIG. 5. As shown in FIG. 6, in the present embodiment, the optical device 300 may further include a color light sensor 160 identical to that in the embodiment of FIGS. 1 and 2 and a controller 170. The color light sensor 160 is configured to generate a sensing signal in response to sensing the ambient light L2. The controller 170 is configured to individually control the light-emitting elements 150 and 350 according to the sensing signal, thereby achieving different color effects, such as theater mode.

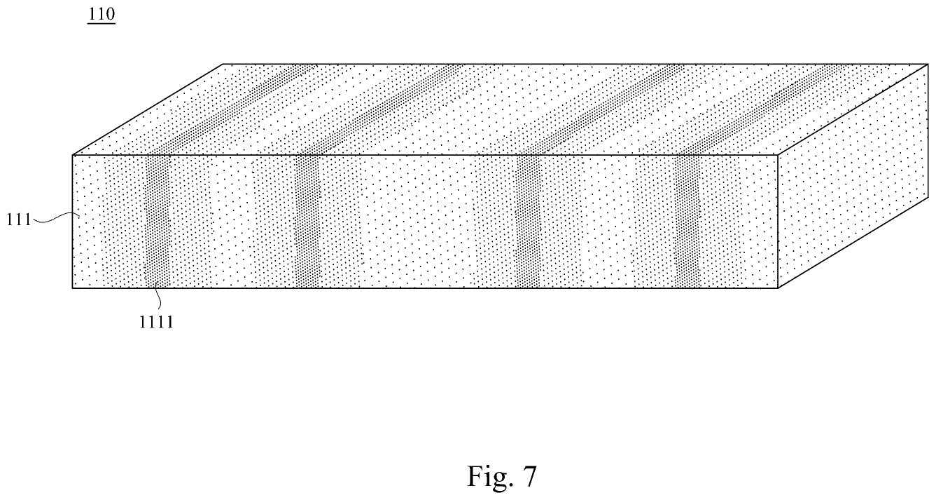

Reference is made to FIG. 7. FIG. 7 is a partial schematic view of the optical combiner 110 in FIG. 2. As shown in FIG. 7, in the present embodiment, the light-transmitting substrate 111 of the optical combiner 110 includes at least one holographic grating 1111. The holographic grating 1111 is configured to diffract the light incident on the optical combiner 110. The holographic grating 1111 of the optical combiner 110 may be a reflective holographic grating or a transmissive holographic grating. The holographic grating 1111 is a volume holographic grating. It is notable that light diffracted by a volume holographic grating can propagate based on the Bragg's law.

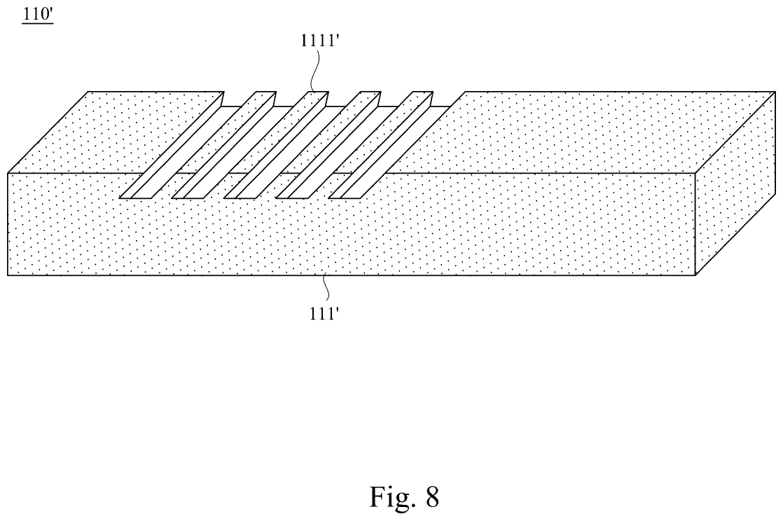

Reference is made to FIG. 8. FIG. 8 is a partial schematic view of an optical combiner 110′ according to another embodiment of the present disclosure. As shown in FIG. 8, in the present embodiment, the light-transmitting substrate 111′ of the optical combiner 110′ includes a plurality of surface structures 1111′. The optical combiner 110′ uses the surface structures 1111′ to form width periodic structures. The surface structures 1111′ may be manufactured to form a surface relief diffraction grating, and the surface relief diffraction grating may form a holographic grating. In this way, the diffraction characteristics of the holographic grating of the optical combiner 110′ formed by the surface relief diffraction grating may be identical or similar to the diffraction characteristics of the holographic grating of the optical combiner 110 formed by the volume holographic grating.

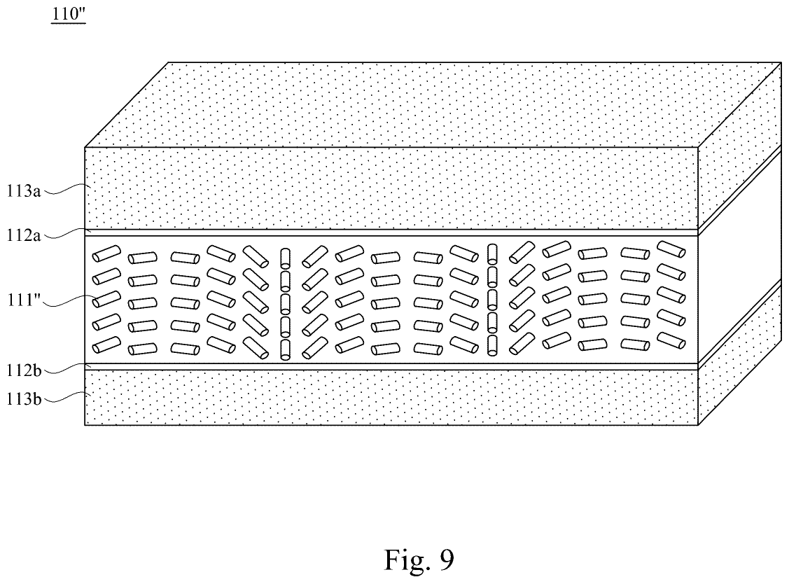

Reference is made to FIG. 9. FIG. 9 is a partial schematic view of an optical combiner according to another embodiment of the present disclosure. As shown in FIG. 9, in the present embodiment, the optical combiner 110″ includes a plurality of liquid crystal molecules 111″ disposed between two photo-alignment layers 112a, 112b, and the photo-alignment layers 112a, 112b are sandwiched between two light-transmitting substrates 113a, 113b. A voltage may be applied to the photo-alignment layers 112a, 112b to rotate the liquid crystal molecules 111″ to form width periodic structures. In other words, the optical combiner 110″ uses the internal liquid crystal molecules 111″ to form width periodic structures, so outer surfaces of the light-transmitting substrates 113a, 113b have no solid structure. The rotated liquid crystal molecules 111″ may form a liquid crystal grating, and the liquid crystal grating may form a holographic grating. In this way, the diffraction characteristics of the holographic grating of the optical combiner 110″ formed by the liquid crystal grating may be identical or similar to the diffraction characteristics of the holographic grating of the optical combiner 110 formed by the volume holographic grating.

In some embodiments, at least one of the optical combiner 110 and the optical combiner 210 may be one of a waveguide element, a reflective lens element, a semi-transparent lens element, and a freeform lens element, but the disclosure is not limited thereto.

According to the foregoing recitations of the embodiments of the disclosure, it can be seen that in the optical combiner and the optical device of the present disclosure, a series of phosphors configured to be excited by a type of invisible light to emit a type of visible light are provided on or distributed within the light-transmitting substrate of the optical combiner. By emitting visible light upon excitation by invisible light, the color of light perceived by the user can be adjusted and enhanced, thereby achieving color balancing and improved visual quality effects for the augmented reality experience. By employing one or more series of phosphors responsive to different invisible light-emitting elements, various color adjustments and effects can be realized, potentially even allowing for dynamic color control. In other words, the present disclosure employs an optical combiner including phosphors that utilize an additive color mixing approach upon excitation by invisible light, thereby enabling effective color management for the generated virtual image that is superimposed on the real world scene. Consequently, the present disclosure effectively addresses issues such as color distortion and limitations in achieving desired color balance encountered in conventional optical devices that rely solely on adjusting the virtual image light-emitting element or are significantly affected by ambient light, thereby enhancing the color fidelity and overall immersion for users within the augmented reality experience. Furthermore, the use of invisible light to excite the phosphors can minimize the visibility of the light-emitting element itself, preventing unwanted visual artifacts.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. An optical combiner, comprising:
a light-transmitting substrate; and
a series of phosphors disposed on the light-transmitting substrate and configured to be excited by a type of invisible light to emit a type of visible light.

2. The optical combiner of claim 1, wherein the series of phosphors are distributed in the light-transmitting substrate.

3. The optical combiner of claim 1, wherein the series of phosphors are disposed on an edge of the light-transmitting substrate.

4. The optical combiner of claim 1, wherein the type of invisible light is infrared light.

5. The optical combiner of claim 4, wherein the infrared light has a wavelength of about 940 nm.

6. The optical combiner of claim 1, wherein the light-transmitting substrate is a diffractive structure or a reflective structure.

7. The optical combiner of claim 1, further comprising another series of phosphors disposed on the light-transmitting substrate and configured to be excited by another type of invisible light to emit another type of visible light.

8. An optical device, comprising:
a light-emitting element configured to emit a type of invisible light; and
an optical combiner disposed in an optical path of the type of invisible light, wherein the optical combiner comprises a series of phosphors configured to be excited by the type of invisible light to emit a type of visible light.

9. The optical device of claim 8, wherein the optical combiner further comprises a light-transmitting substrate, and the series of phosphors are distributed in the light-transmitting substrate.

10. The optical device of claim 8, wherein the optical combiner further comprises a light-transmitting substrate, and the series of phosphors are disposed on an edge of the light-transmitting substrate.

11. The optical device of claim 8, wherein the type of invisible light is infrared light.

12. The optical device of claim 11, wherein the infrared light has a wavelength of about 940 nm.

13. The optical device of claim 8, wherein the optical combiner further comprises a light-transmitting substrate, and the light-transmitting substrate is a diffractive structure or a reflective structure.

14. The optical device of claim 8, further comprising another light-emitting element configured to emit another type of invisible light, wherein the optical combiner is disposed in an optical path of the another type of invisible light and further comprises another series of phosphors configured to be excited by the another type of invisible light to emit another type of visible light.

15. The optical device of claim 14, further comprising a controller configured to individually control the light-emitting element and the another light-emitting element.

16. The optical device of claim 8, further comprising:
a color light sensor configured to generate a sensing signal in response to sensing ambient light; and
a controller configured to control the light-emitting element according to the sensing signal.
